(19) United States
(12) Patent Application Publication
(10) Pub. No.: US 2011/0218777 A1
(43) Pub. Date: Sep. 8, 2011

(54) SYSTEM AND METHOD FOR GENERATING A BUILDING INFORMATION MODEL

(75) Inventors: Henry Chen, Beijing (CN); Cheng Jun Li, Beijing (CN); Tom Plocher, Hugo, MN (US)

(73) Assignee: Honeywell International Inc., Morristown, NJ (US)

(21) Appl. No.: 13/038,228

(22) Filed: Mar. 1, 2011

Related U.S. Application Data
(60) Provisional application No. 61/310,217, filed on Mar. 3, 2010.

(51) Int. Cl. G06F 17/50

(52) U.S. Cl. 703/1

(57) ABSTRACT

In an embodiment, a computer implemented method and system obtains a floor plan in a vector image format. Template driven searching is performed by a computer system to extract basic building structures. In another embodiment, a CAD-based vector image is received into a computer processor. An object is recognized and extracted from the vector image. The object is exported into a building information model compliant to ISO/PAS 16739 (Industry Foundation Classes) or OmniClass™.

### RELATED APPLICATIONS

This application claims the benefit of priority under 35 U.S.C. Section 119(e) to U.S. Provisional Application Ser. No. 61/310,217, filed on Mar. 3, 2010, which is incorporated herein by reference in its entirety.

### BACKGROUND

A topological or layout structure of a floor plan may be useful for various applications. If the perimeters of a room or the location of a door or stairs are known, the information may be used as input data for fire and smoke propagation prediction applications, as input data for a route retrieval for evacuation planning application, or even in a verbal description of developing conditions in spatial geometries. The structure can include location, shape and boundary of the compartments, such as rooms, stairs, elevators, open spaces on a floor, or cubicles in a room, and further can include connectivity between different compartments

A Building Information Model (BIM) describes a building structure or topology (e.g., walls, doors, elevators, stairwells, location, shape and boundaries of the compartments) as semantic objects grouped into standard classes. Each class of objects has standard properties such as physical dimensions, but can also be assigned special properties such as the R-values for windows and doors, fire ratings for doors and walls, and trafficability of a space. This BIM information can be used to rapidly and automatically generate 3D graphical renderings of buildings. It can also be used in a range of other applications from energy management to evacuation planning.

CAD-based vector images, such as floor plans, typically show some structural objects (for example, doors, elevators, stairs) and some device objects (for example, smoke detectors, speakers, and pull stations). The placement of an object on the CAD drawing implies its location, but it is only a location on a drawing, not the device's actual geo-location in the building. Likewise, such graphical objects on a CAD drawing representing devices often are shown near a text box that contains a label indicating the identification of the device. Also, AutoCAD drawings often associate a tag with each device object and the tag indicates the device's network address. However, these are only graphical objects placed on the floor plan image and have no functional connection or association to the device network database. So while the CAD drawing contains useful information about the type, location, identity, and addresses of devices, it is image-based information rather than semantic-based and so is not exportable into a building model or other applications.

Additionally, few buildings currently have a BIM. Most existing buildings come with floor plan drawings represented as a scalable vector image rather than as semantic information. They are pictures, commonly in DWG (Drawing) and DXF (Drawing Interchange Format) formats by Autodesk. In most cases, these floor plans contain a clutter of various objects on the image (e.g. electrical conduits and smoke detectors) along with the principal structural features of interest such as the walls, doors, elevators, and stairwells. Rendering 3D graphics from these floor plan images is difficult and requires an enormous amount of manual cleanup. Such cleanup is time-consuming and the result is still an image that is inflexible, agnostic to the properties and attributes of various structures, and also difficult to update. Further, other applications that require a description of building features as semantic information (e.g., a BIM) cannot use such image-based structural data.

### BRIEF DESCRIPTION OF THE DRAWINGS

FIGS. 1A, 1B, 1C, and 1D illustrate different boundary styles of a compartments in a drawing.

FIG. 2 is a block diagram of a topology extraction system.

FIG. 3 illustrates a structure boundary thinning process.

FIGS. 4A, 4B, 4C and 4D are a room drawing sample.

FIG. 5A illustrates how a wall can be twisted by columns with different sizes.

FIG. 5B. illustrates how a wall can be twisted by adjacent rooms.

FIG. 6A shows rooms in a source floor plan. FIG. 6B illustrates the result after the room extraction.

FIG. 6C shows cubicles in a source floor plan. FIG. 6D illustrates the result after cubicle extraction.

FIG. 7A illustrates an appearance of two mirrored doors in an architectural drawing.

FIG. 7B illustrates the names of speakers (SPs) that have different relative locations.

FIGS. 7C, 7D, and 7E illustrate stairs with three different styles.

FIG. 8 is a block diagram of an object extraction system.

FIG. 9A illustrates a display of a sample object.

FIG. 9B illustrates a schema setting table.

FIG. 10A illustrates the primitives for a speaker.

FIG. 10B illustrates the fragments for the speaker primitives of FIG. 10A.

FIG. 11 illustrates the fragment structure of the primitives for the speaker of FIG. 10A.

FIG. 12 illustrates an example of a virtual primitive.

FIG. 13 is a block diagram of a computer system that executes programming for performing methods described herein.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

The popular format for drawing the layout structure of a floor plan drawing, which normally is represented as a scalable vector image due to its significant properties, is DWG (Drawing) and DXF (Drawing Interchange Format) by Autodesk for the CAD (computer aided design) application, IGES (Initial Graphics Exchange Specification), STEP (Standard for the Exchange of Product Model Data), SVG (Scalable Vector Graphics), and others. In most cases, these floor plans contain various objects inside the floor plan (e.g. electrical conduits and smoke detectors) along with the layout of various rooms, elevators, and stairwells. In order for the above-mentioned applications to work, it is desired to be able to accurately identify and extract the topology or the layout of the floor plan (e.g., external building perimeter, rooms, doors, and stairs).

Although various methods for extracting the objects from raster images or vector images have been proposed, extracting topology or layout structure information from the floor plan files is very challenging. Most object extraction methodologies are based upon pattern matching by comparing the target object with a sample pattern of the object. Since various structures in a topology may not have a fixed pattern (e.g., rooms can be of various shapes or sizes), pattern matching methodologies cannot be extended to reliably extract the topology or layout information. Even if a particular pattern exists (four walls and a door with a fixed dimension), there could be several ways to draw the boundaries (walls) of the pattern.

In an embodiment, a method extracts building structure as semantic information from a vector image of a building and organizes it as a building information model, compatible with IFC formats. A template-driven detection method extracts basic building structures, such as stairs, doors, and elevators. A template is composed of primitive properties points, lines, curves, and text. Users can predefine the template or temporarily define a template. In some embodiments, a wall line thinning method may be utilized. For a floor plan of the building, its structure boundaries take on various parallel lines or curves to represent walls, windows and so on. The wall line thinning method merges the end vertices of the parallel lines or curves across the boundary so as to simplify the boundary into a set of line segments and to ensure no two lines along the boundary are at the same location. The line segments are organized as a graph data structure, which provides several advantages in further processing, such as structure verification.

In another embodiment, a structure verification method is utilized. In addition to refining wall lines by primitives in a drawing, wall lines may be further refined according to normal structural design rules. As a result, wall line extraction precision may be significantly improved.

In a further embodiment, an intelligent space search method is utilized. The space search method can distinguish a room and a cubicle, and can associate names to the room and cubicle spaces.

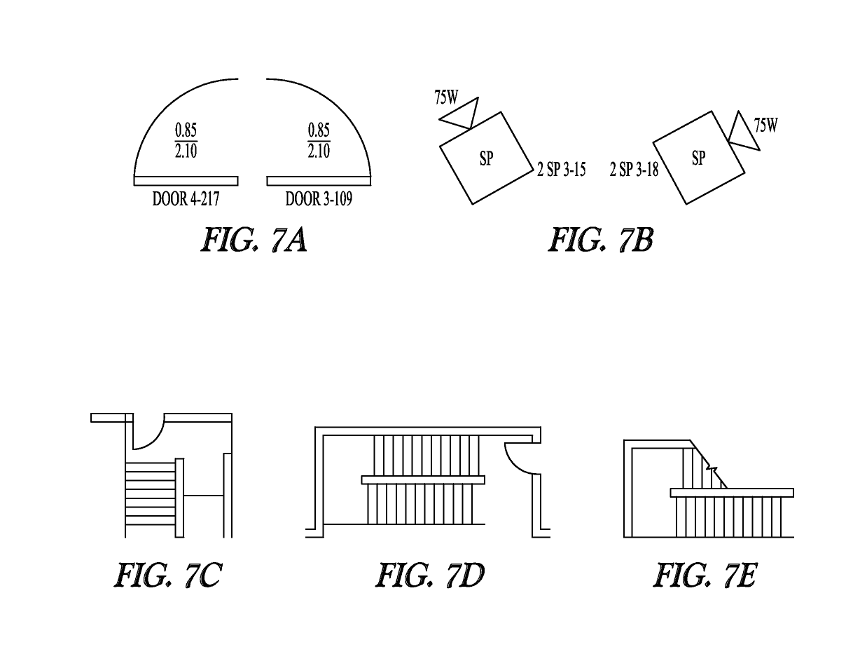

A specific embodiment particular to CAD drawings is outlined below and in FIGS. 7-12.

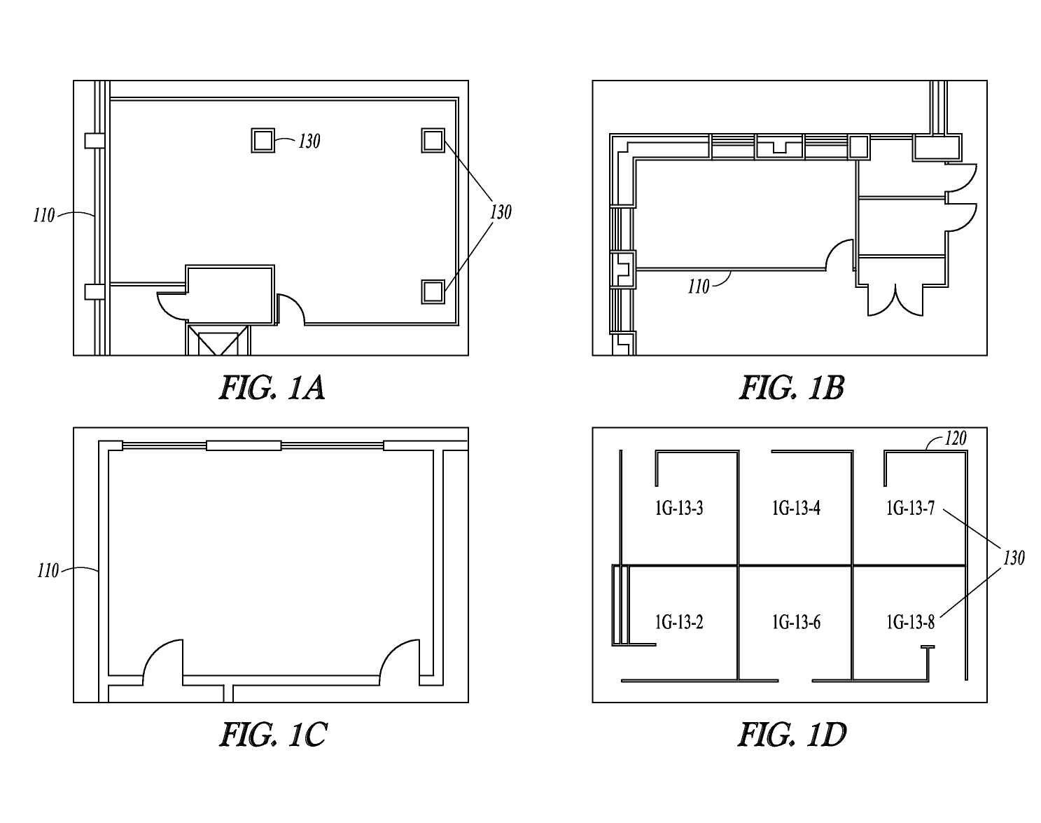

FIGS. 1A, 1B, 1C, and 1D illustrate four boundary styles of a compartment—three kinds of walls 110 with various widths and shapes, and a cubicle boundary 120. In addition to the different styles, there can be non-structure type objects in the floor plan that can complicate the topology or the layout of the floor plan. The devices or annotations 130, irrespective of the topological structure, are often drawn on a floor plan, as shown in FIGS. 1A-1D. Some products can include the topology or layout structure so that they can be retrieved. For example, to support the BIM (Building Information Model) format, ArchiCAD from GraphiSoft, Revit Architecture from AutoDesk and Microstation from Bentley Systems can integrate the information as IfcSpace. But in most cases they are in a proprietary format or domain. The historical legacy building data does not include the BIM information and it is tedious and inefficient to manually convert it into BIM data.

In various embodiments, a method extracts topological or layout structure information for vector images. The method may be applied to a raster image of a floor plan if the geometric primitive (such as a line, an arc, a circle, or text) detection algorithms are properly designed. One example method operates to extract building structures as semantic information from a vector image of a building and organize it as a building information model, compatible with IFC formats.

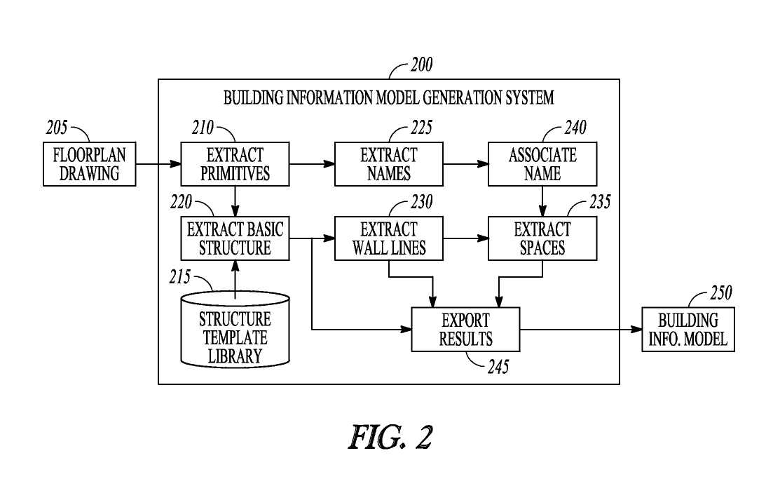

FIG. 2 is a block diagram of a topology extraction system 200 that illustrates a framework for implementing the methods.

An Extract Primitives module 210 searches for geometrical primitives from the inputted floor plan drawing 205. Geometrical primitives can include points, lines, curves, and text. Some templates may be predefined for basic structures (such as stairs, doors, and elevator), and stored in a structure template library 215. With these templates, corresponding structures in the drawings may be searched for using an Extract Basic Structure module 220. Templates may be set to search the space names via an Extract Names module 225. These templates may include wildcard strings or other properties such as color, font, and size.

An Extract Wall lines module 230 enables a user to set a wall width. An approximate width value may be used instead of a precise value. In one embodiment, a user may set the width value by simply drawing a line across the boundary, such as a wall, which makes it easy and intuitive. In the Extract Wall Lines module 230, a boundary thinning algorithm will generate some line segments along the boundary. The Extract Wall Lines module 230 may also refine wall lines via structure verification methods. Wall lines may be refined by primitives in the drawing, and also may be refined according to normal structural design rules.

An Extract Spaces module 235 can detect a room or cubicle via pre-defined rules. A room can be defined as a simple cycle with door(s) on the edge and the cubicle can be defined as some connected edges on the graph whose shape is similar to a square and whose open part is less than 25%.

Generally, the topology extraction system 200 shown in FIG. 2 may include basic structure extraction via predefined templates, wall lines extraction via structure boundary thinning, wall lines refinement via structure boundary verification, and spaces extraction and association of space names (240). The BIM generation system 200 includes an Export module 245 that exports the generated BIM model 250.

Basic building structures such as stairs, doors, and elevators may interfere with the wall line extraction. In one embodiment, the stairs, doors and elevators may be extracted and removed from the drawing. A template-driven extraction method may be used. One example template may be predefined as show below:

| Stair | Elevator | Door |
|---|---|---|
| >6 lines | 2 lines | has an arc |
| has similar length | with length between A and B | radian between Pi/6 and Pi/3 |
| with length between A and B | has similar length | and has a line |
| with adjacent distance <.3 | with distance = 0 | an end point is on the arc |
| len | with angle degree >30 | other end point is close its center |
| with angle degree = 0 | | |

The first line includes names that identify the template. The name may be searched via a wildcard string. Other features may be adopted to distinguish its properties, such as color, font, and size.

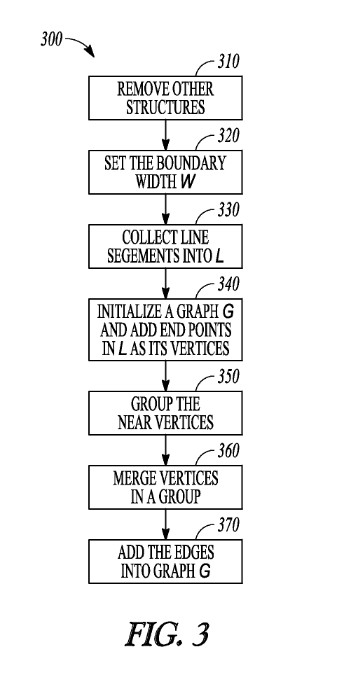

The structure boundary thinning process 300 is illustrated in flowchart form in FIG. 3. In one embodiment, graph data structures may be used to implement the algorithm. The end points of the primitives may be mapped into the vertices of the graph, and then the near vertex pairs are merged according to the boundary width threshold. For each primitive, an edge may be added into the graph if it has no corresponding edge. As a result, the boundary may be simplified into the edges of the graph to ensure that no two edges along the boundary are at the same location.

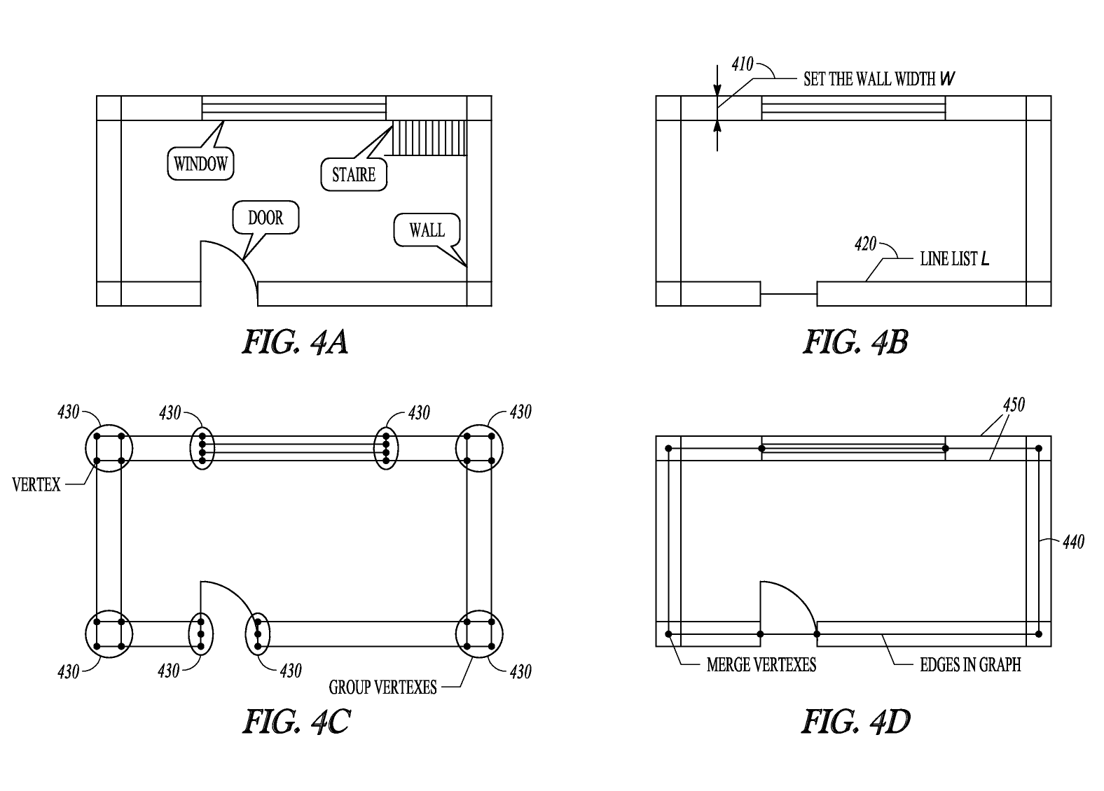

At 310, other structures may be removed with templates (FIG. 4A), such as doors, stairs, and elevators. At 320, the boundary width may be set (FIG. 4B). A user draws a line segment across the boundary on the vector image display window (FIG. 4B, No. 410). Its length will be automatically calculated and recorded as a width threshold w. At 330, line segments are collected (FIG. 4B, No. 420). A line segment is defined as l=<a,b>, where a and b are two end points. After primitive retrieval, all the line segments are collected into a list L={l}. Poly lines and polygons are decomposed into line segments. A poly line is a line made up of two or more line segments. Curves are also converted into line segments with two end points. Doors usually bring breaks to the room boundary, thus it is represented as a line segment.

At 340, a graph is initialized, along with its vertices. A graph is defined as G=<V,E>, where V is a list of vertices, E is a list of edges, and an edge e=<i,j>, i and j are two integer indices indicating two vertices in V. A graph G=<V,E> is built by filling its vertex list V with the end points of the line segments 1 obtained at 320. That is, for each line segment l in L, the two end points of l are added to V (solid dots in FIG. 4C at 430).

At 350, the graph is searched for all the vertices with distance under a threshold value d. The vertices found are grouped. Here d=(1+ε)×\sqrt{2}×w, where w is specified by a user, and ε>0 is a tolerance, e.g. 0.05.

At 360, the vertices are merged in a group (their length is less than d) into a vertex. In other words, if a vertex is not to be grouped, it remains unchangeable; otherwise, all vertexes in a group are converted into a vertex, whose position is the center of bounding box of the group (FIG. 4D, No. 450). At 370, the edges are added to the graph. Each line segment l in L is checked. If the two endpoints of l are mapped to two different vertices of the graph, an edge is added to the graph; otherwise, l is ignored. At the same time, duplicate edges are ignored. All the edges for the room in FIG. 4A are shown as solid lines 440 in FIG. 4D.

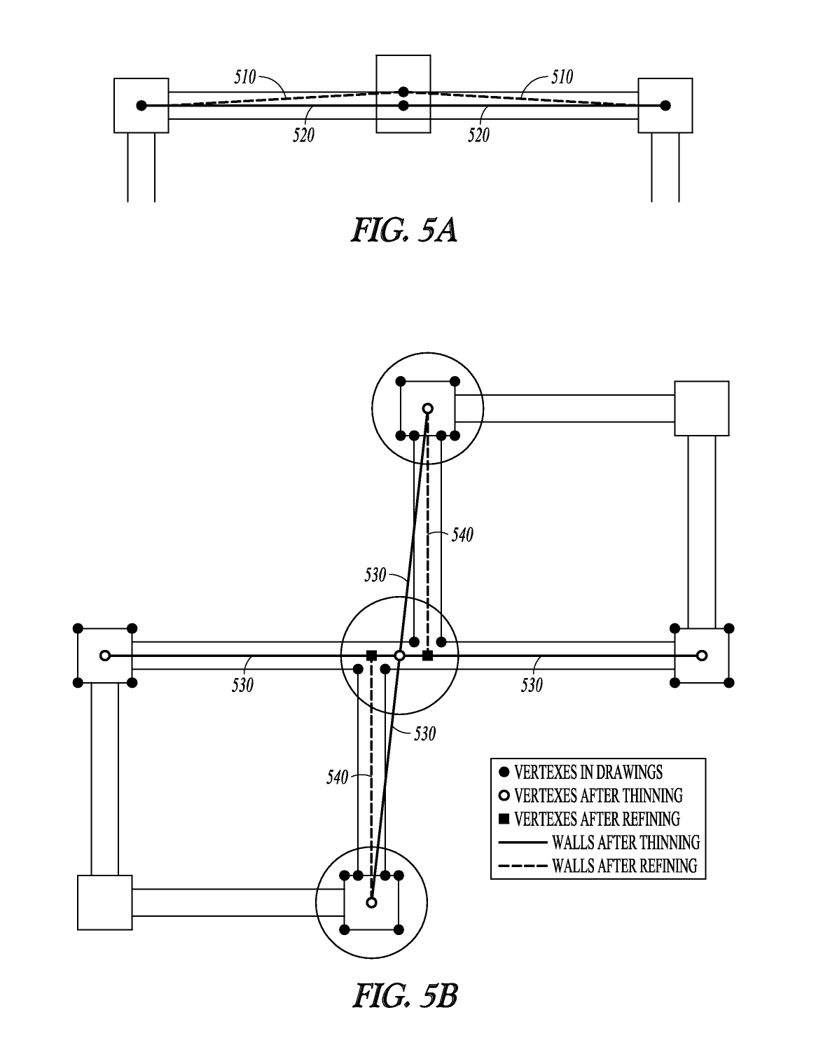

After the structure boundary thinning, some structure details may be thrown away. This can lead to the result that the boundary is slightly different from the original boundary. For example, FIG. 5A illustrates how a wall can be twisted a little by the columns with different sizes at 510, and then how the wall can be refined at 520. The wall also can be twisted a little by adjacent rooms, as illustrated at 530, 540 in FIG. 5B. In some embodiments, the resulting boundary may be evaluated and corrected if possible.

In one embodiment, the boundary evaluation process can be described as follows:

| | |
|---|---|
| 1 | for each edge e in graph G , ∀e ∈ G , get its two vertices v₁, v₂ |
| 2 | Get the end points set P₁ for v₁ and P₂ for v₂ |
| 3 | Initialize a line segment set K |
| 4 | for each end points in p₁ ∈ P₁ and p₂ ∈ P₂ |

| | |
|---|---|
| 5 | if p₁p₂ is a line segment of the floor plan image |

| | |
|---|---|
| 6 | add p₁p₂ into K ; |

| | |
|---|---|
| 7 | if v₁v₂ is parallel to the K |

| | |
|---|---|
| 8 | v₁v₂ is valid; |

| | |
|---|---|
| 9 | Else |

| | |
|---|---|
| 10 | v₁v₂ is invalid; //it will be refined as disclosed below |

In a further embodiment, the wall line may be evaluated by primitives in a drawing, and also may be verified as a function of normal structural design rules. FIG. 5B illustrates verification of wall lines by primitives in a drawing.
Get a vertex from thinning result
Get its related vertices in a drawing due to grouping operation
Get the related lines in the drawings
Check if the line after thinning is parallel to line in the drawings
Split the vertex from thinning into two vertices to maintain the geometric topology
   The normal structural design rules may include:
Removing tiny structures
Removing T-junctions
Making corners perpendicular
Making walls as straight lines (as shown in FIG. 5A)
Merging straight edges so as to get a whole wall

The boundary refining process tries to move the vertex in the graph and ensure the edges on the graph are parallel to the line segments on the source floor plan drawing. The process may be described in one embodiment as:

| | |
|---|---|
| 1 | for each edge e in a graph G , ∀e ∈ G , get its two vertices v₁, v₂ |
| 2 | if v₁v₂ is invalid |

| | |
|---|---|
| 3 | // how to get K is similar to boundary evaluation process |
| | get the related line segment set K |
| 4 | move v₁ and v₂, get virtual vertex v₁′ and v₂′, which satisfy |
| | v₁′ v₂′ is in the center of K |

| | |
|---|---|
| 5 | for each vertex v in the graph G , ∀v ∈ G |

| | |
|---|---|
| 6 | get its virtual vertex set V |
| 7 | if ∀v′, v″ ∈ V, \|v′v″\| ≦ δ |

| | |
|---|---|
| 8 | // refine boundary successfully |
| | merge V into a vertex and replace v |

| | |
|---|---|
| 9 | Else |

| | |
|---|---|
| 10 | // it is a singular point, remind user |
| | split v into multiple vertices and connect them to v |

In an embodiment, lines 7 to 10 of the above process refine the boundary. The solid lines that are not part of the initial boundary in FIGS. 5A and 5B are the boundaries obtained after the boundary refining process. In FIG. 5A, the boundary is refined successfully, or in other words, the virtual vertices can be merged into a vertex so as to replace the original one. But in FIG. 5B, a singular point is obtained, and in that case, the process splits v into multiple vertices and connects them to the original vertex v. At the same time, the process may remind the user to manually deal with the singular point if necessary.

In further embodiments, other information may be used to refine the boundary. For example, by reading the text, structures like stairs, elevators, or even parking lots may be located. That is, a floor plan can include a campus layout of several buildings.

After the above processes—boundary thinning and boundary verification—a refined graph G results whose edges are the boundary of the structure. The next task is to search the structure on the above graph G. The features of an example structure of a room include a simple cycle on the graph that includes a door on its edges. The features of an example structure of a cubicle include a similarity to a square, an open polygon, with the open part less than 25% of the whole.

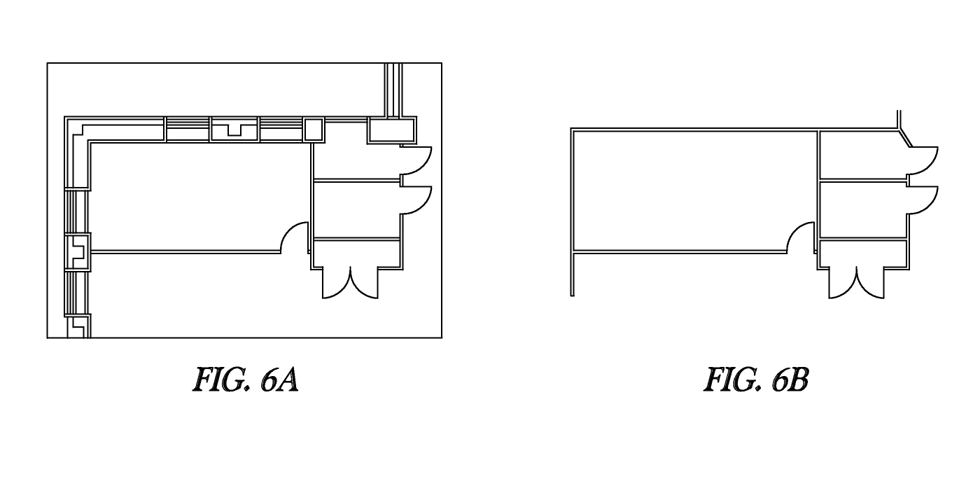

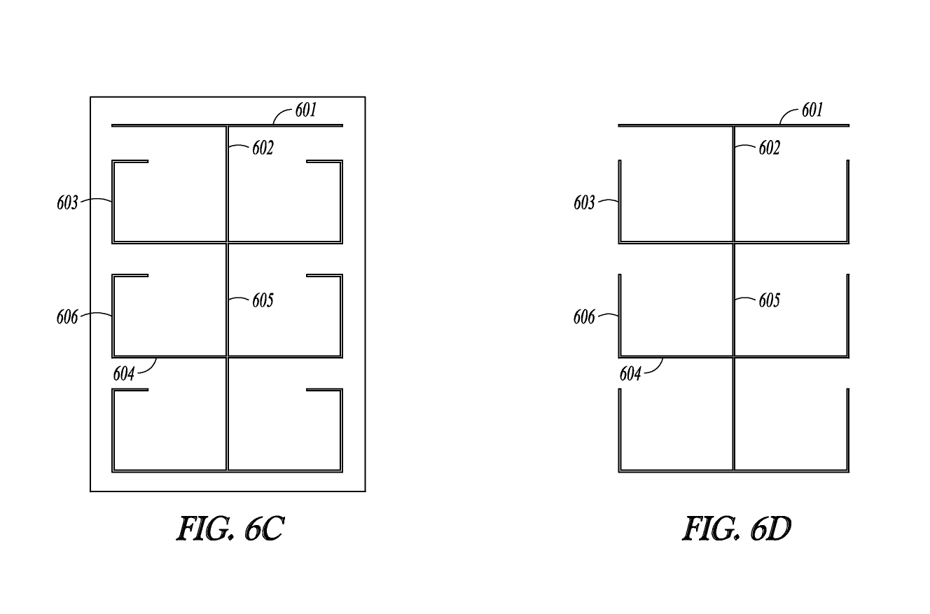

With the graph G and the definition of the room, it is easy to search for the rooms in the graph. First, all the simple cycles in the graph are detected with a cycle detection algorithm. A check is made to determine if there is a door(s) on the edges for every cycle. If some edges on a simple cycle are converted from the door, the simple cycle will be regarded as the boundary of a room and its door is also determined. FIG. 6A shows some rooms in a source floor plan, and FIG. 6B illustrates the result after the room extraction. Similarly, FIG. 6C shows some cubicles in a source floor plan, and FIG. 6D illustrates the result after cubicle extraction.

With the graph G and the definition of a cubicle, a search for cubicles in the graph may be performed. For each edge in the graph, a search is done for possible similar edges (with the nearly same length) in its adjacent area according to the square template. For example, in FIG. 6C, for the line 1, the search finds lines 601-606. A check of connectivity of these lines results in two possible cubicles for the line (one cubicle is surrounded by the lines 601, 602, and 603, and the other is surrounded by lines 604, 605, and 606). The open part of the candidate cubicles is checked to ensure it is less than 25%.

Next, a determination is made if a name text is in a polygon. If it is, a name is assigned to the polygon space.

The method may also generate a campus or other facility semantic model. In one example embodiment, buildings can be generated from CAD drawings. Although the method of object extraction from raster images can be applied to handle vector images by converting vector images into raster images, various merits of vector images are lost by rasterization. Topological or structure extraction is challenging due to the complex boundary styles for the structure. Topological extraction is facilitated in one embodiment by boundary thinning and boundary verification mechanisms. The graph data structure represents the floor plan so that it is easy and effective to search the structure defined with different features.

### CAD Embodiment

CAD drawings contain useful information about the type, location, identity, and addresses of devices. However, it is image-based information rather than semantic-based, and so is not exportable into a building model and other applications. If it were possible to extract the object and its attributes as semantic information, then it could also be organized hierarchically according to standard IFC (International Foundation Class) object classes. In other words, a Building Information Model for the building could be created where none previously existed. As a result, many applications could be supported. Classes of devices or structural objects of interest could be selected, and 2D and 3D building graphics could be automatically and rapidly populated, thereby displaying the objects at the correct locations in the building. Additional attributes could be added, such as behaviors, to classes of objects in the building model, the additional attributes could be associated with a data source, and a real time visualization could be generated to display how those devices are performing. In the fire prevention and detection industry, smoke detectors could be quickly configured in a graphical annunciator panel, and the smoke detectors could be automatically and instantly associated with the physical devices of the fire safety network for the building. In the HVAC industry, visualizations of functioning HVAC equipment and temperatures around the building could be created.

However, a problem is that, until now, there has been no good way to automatically recognize and extract objects from vector images/CAD drawings with a high degree of accuracy, flexibility, and processing speed, and export them into an IFC-compatible Building Information Model. An embodiment described herein solves this problem.

An embodiment solves the problem by proposing a flexible method for describing the object's structure and using that schema to extract all similar objects from a drawing. With this well-organized structure, an embodiment can effectively and robustly retrieve all similar objects irrespective of their size and orientation. The retrieved similar objects then can be easily grouped into standard IFC object classes, creating a building semantic model where none existed.

A novelty within an embodiment lies in a method for describing the sample object's structure in two levels. It can be referred to as a Primitive Structure Model. In a vector image, an object is always composed of primitives (shape, color, line width). So it is necessary to find an effective method to describe its structure so it can be decided whether two objects belong to the same category. This can be done at two levels. At the lower level, similar primitives are grouped into what is called a primitive fragment, which captures the partial micro structure of the sample object. At the second and higher level, all primitive fragments are formed into fragment structures. These hold the macro structure of the sample object. Decomposition of the structure into two levels makes it is possible to avoid the redundancy caused by internal symmetry in the sample object. With this well-organized structure, an embodiment can effectively and robustly retrieve similar objects from a drawing irrespective of their size or orientation.

An embodiment also introduces the novel idea of an “output template” which contains semantic information about the object, such as location, orientation, and annotation (e.g., ID, network address, length, and volume).

Various techniques have been developed for object detection. Some have taken contours as the recognition cue. Contour in this context means the outline together with the internal edges of the object and its contour. However, these techniques apply only to raster images. Embodiments herein detect the objects from vector instead of raster images, permitting higher accuracy and speed of performance.

A vector image can retain significant semantic information about the intent of the graphic and how it was created. The hierarchy of the points, lines and areas defining the image are often significant properties of the image, and hence they are widely used in various domains. For example, in a CAD based vector image, the specific information of an object, such as its ID, location and so forth, is very important for many applications. Particularly in the fire prevention and detection industry, smoke detectors can be configured in a graphic annunciator, and can be associated with the physical devices of the fire safety network of the building. Alternatively, an embodiment can also be used to estimate the price of an HVAC system and design the optimal pipe routing according to the number and location of these devices.

If the object information was simply inputted manually according to the vector images, that would be tedious, inefficient and error-prone. However, since the information can be inferred from the drawings, that information can be automatically extracted from the vector images. Although various object extractions for raster images have been proposed, none of them has a mechanism to handle vector images. Therefore, in order to extract object regions from vector images using currently available technology, it is necessary to convert vector images into raster images. However, various merits of vector images are lost by rasterization. Some products can encapsulate some geometric objects as an object block and attach text properties to the block so that the object can be retrieved via the text properties. For example, to support the BIM (Building Information Model) format [BIM 2008], ArchiCAD from GraphiSoft, Revit Architecture from AutoDesk, and Microstation from Bentley Systems can integrate these properties. But it is only applicable to the proprietary product or domain.

As noted above, a vector image is composed of geometrical primitives such as points, lines, curves, and text. The objects in the vector image are composed of these primitives. Consequently, an embodiment extracts objects by analyzing geometric information of the primitives, such as shape, color, line width and so forth, not unlike human vision. But the straightforward analysis of the primitive only works on some limited scenarios. For example, in a typical system, an object, in its rotated, scaled, mirrored form may belong to one category, as FIG. 7A shows with two mirrored doors. The internal structure of the object, such as symmetry, makes the problem more complex. The objects in one category can even have different appearances, while at the same time have some similar intrinsic geometric properties. For example, FIGS. 7C, 7D, and 7E show stairs with three different styles, but they have the same intrinsic property—a group of parallel line segments with the same length, angle and distance. In addition, once an object is extracted, it is also important to obtain other relevant information, such as location, orientation and annotation. Although this information is linked with the specific object, there is no predefined or prescribed way to denote the linkage. This information can be placed in close proximity to the specific object, but arbitrary placement of the relevant information, e.g. annotation, makes the problem more complex. For example, FIG. 7B shows the names of speakers (SPs) that have different relative locations. There does not exist a flexible, robust, and effective method to extract the above identified objects and extract any of their related information for the versatile vector images. However, one or more embodiments address this need.

Various embodiments extract the objects similar to the sample from the vector image and output any of its relevant information, such as location, orientation, and annotation.

In some embodiments, a primitive structure model is used. By defining and combining the properties of the primitives and the similarity measures between the primitives, the model provides a flexible method to describe the object's structure. With the well-organized structure, one can effectively and robustly retrieve a similar object irrespective of its size and/or orientation.

In further embodiments, a method describes the sample's structure in two levels with the above primitive structure model. At the lower level, the similar primitives are grouped into a primitive fragment, which keeps the partial micro structure of the sample object. At the higher level, all primitive fragments are formed into the fragment structure, which holds the whole macro structure of the sample object. Decomposition of structure into the two levels avoids the redundancy caused by internal symmetry in the sample object.

Further embodiments include a method to output any relevant information of the object, such as location, orientation, and annotation (ID, length, and volume for example), by setting an output template. The template includes which fragment information will be outputted as the partial micro information, and includes some virtual primitives relative to the sample object as the whole macro information. Once an object is recognized from the vector image, these virtual primitives will also be calculated and outputted according to the fragment structure. For example, the retrieved similar objects then can be easily grouped into standard IFC object classes, creating a building semantic model where none existed.

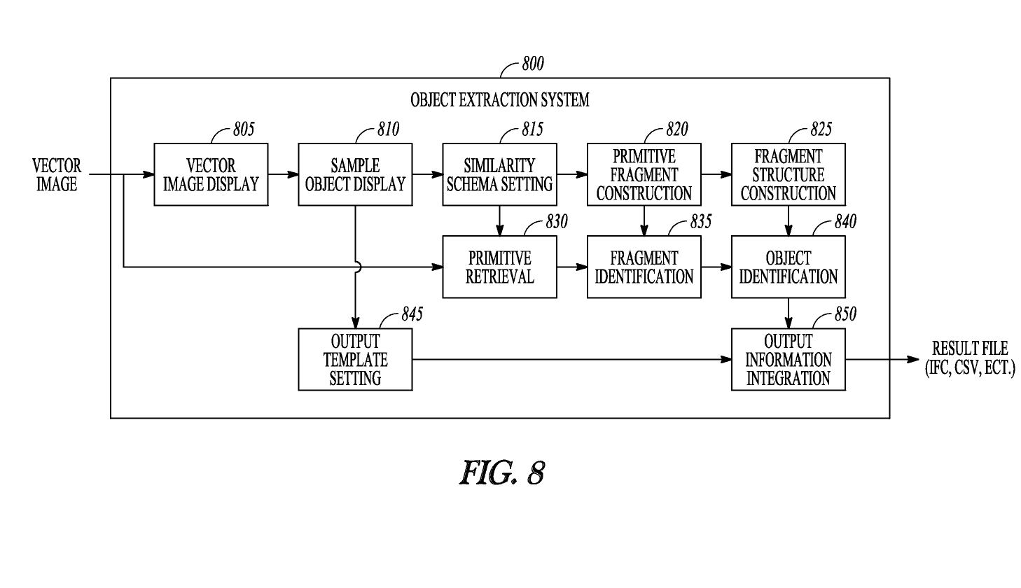

FIG. 8 is a block diagram of an object extraction system 800. Vector Image Display 805 is for the user to browse a vector image or select a sample object. The sample will be drawn and its primitives are listed in an editable Sample Object Display window.

Sample Object Display 810 allows a user to specify the schema about how to match its primitives via the Similarity Schema Setting module 815. The schema includes which primitive will be considered, how to compare primitives, what the text validation string expression is, and so on. A default similarity schema can be generated by the system in case no schema is provided by the user.

Similar primitives will be organized into a primitive fragment via the Primitive Fragment Construction module 820. The fragments will be formed into a higher-level structure via the Fragment Structure Construction module 825. The Primitive Fragment and Fragment Structure are described with the Primitive Structure Model.

The Primitive Retrieval module 830 searches primitives with similar properties and shape of a primitive in the similarity schema from the vector image. The Fragment Identification module 835 searches the fragments for the same or similar primitive fragment from these primitives, and the Object Identification module 840 searches the objects with the same or similar fragment structure from the fragments.

The Sample Object Display allows a user to designate an output template via the Output Template Setting module 845. The template comprises any information about the sample object, such as drawing a point as its location, drawing a vector as its orientation direction, setting a text primitive as its ID, and so on. A default output template can be generated by the system in case there is no template by the user. The meaningful information for every extracted object will be obtained according to the output template via the Output Information Integration module 850.

Generally, the object extraction system 800 shown in FIG. 8 includes four steps, they are sample selection (805, 810), sample structure construction (815, 820, 825), object extraction (830, 835, 840) and obtaining relevant information (845, 850). The initial step of sample selection can be accomplished by one or more techniques known to those of skill in the art, and these techniques will not be discussed further.

1. Primitive Structure Model

In a vector image, an object is always composed of some primitives. So it is necessary to find an effective method to describe its structure or appearance to decide whether two objects belong to the same category. It is helpful to define some possible properties that can be used to find similarities between the primitives. In addition to the properties listed below, such properties can includes color, filled-color, line-width, text size, and text font.

Shape: The shape of a primitive (other than text) means one or more straight or curved lines from one point to another. If p₁ and p₂ are two primitives, it can be stated that p₁ and p₂ have the same shape if and only if p₁ and p₂ can overlap with each other after some rotation and translation. This relationship can be expressed as S(p₁)=S(p₂). The shape of a primitive can be represented as two values—one the Euclidean distance of two end points and the other the distance along the curve from one end point to another end point.

Furthermore, if t₁ and t₂ are two text primitives (which can be the annotation of objects, or the attributes of some Block of primitives, e.g., BlockRef of DWG or DXF), and w is a validation string expression (which may be a wildcard string, such as “door*_*” or “*sp*-*”; or a regular expression, such as a three digit number with the expression [0˜9] {1,3}), it can be stated that t₁ and t₂ have the same shape w if and only if t₁ and t₂ match with w. This expression can be written as S_{w}(t₁)=S_{w}(t₂).

Besides the shape and text, other attributes, such as color, the filled color, line width, text size, and text font, can be considered as the similarity measures between two primitives.

Distance: If p and q are two primitives, the distance of p and q means the distance from the center of p to the center of q. This can be expressed as D(p,q). In an embodiment, the center of a primitive can be defined as the middle point of line segment formed by its two end points. The center of a point is itself and the center of a text is its center. In other embodiments, other definitions are also applicable. The distance of p₁ and q₁ is the same as the distance of p₂ and q₂ if and only if D(p₁,q₁)=D(p₂,q₂).

Angle: If p and q are two primitives, the angle of p and q means the angle between the line segment formed by two end points of p and the line segment formed by two end points of q. This can be expressed as A(p,q). The angle of p₁ and q₁ is same as the angle of p₂ and q₂ if and only if A(p₁,q₁)=A(p₂,q₂).

Orientation: If p and q are two primitives and r is a reference primitive, the angle of p and q based on r means the angle between the line segment formed by the center of p and r, and the line segment formed by the center of q and r. This can be expressed as Aᵣ(p,q). The orientation of p₁ and q₁ on r is the same as the orientation of p₂ and q₂ on r if and only if Aᵣ(p₁,q₁)=Aᵣ(p₂,q₂).

Primitive Structure Model

If an object is composed of a set of primitives O={p₁, p₂, . . . , pₙ}, the structure of the object can be represented as the properties of its primitives and relations among them. The properties can be a shape, the properties can be text defined as previously disclosed. The relations can be distance, angle, or orientation as defined above. So the structure of the object can be represented as multiple matrixes. These matrixes include adequate information, yet they also include redundancy. To remove the redundancy, a primary primitive is identified.

Consequently, the Primitive Structure Model can de defined as follows: M≡<p,Q>. Here, pεO is a primary primitive. Q={<S(q),D(p,q),A(p,q),Aₚ(h,q)>|q εO}, Q is a primitive list with several properties. In an embodiment, the shape of text primitive is defined as its text string. In the expression for Q, h is a virtual primitive, and it can be any primitive of the object except the primary primitive. The S(q),D(p,q),A(p,q),Aₚ(h,q) have been defined above. Some of them can be selected to describe the properties for an object. For example, to search the stairs shown in FIGS. 7C, 7D, and 7E, the stairs can be modeled as any object with several parallel lines with the same shape and angle in an area. Though the stair model can suggest other non-stair objects, it is still an effective model to search for stairs in a floor plan vector drawings. With the flexible combination of the primitives' properties, similar objects with similar measures can be effectively and robustly retrieved among the primitives.

2. Sample Structure Construction

Once a sample object is selected, the next question is how to build its structure with the above Primitive Structure Model. An embodiment describes its structure in two levels. In a lower level, the similar primitives are grouped into a Primitive Fragment, which keeps the partial micro structure of the sample object. In a higher level, all Primitive Fragments are formed into the Fragment Structure, which holds the whole macro structure of the sample object. Decomposition of structure into two levels avoids the redundancy caused by internal symmetry in the sample object.

Similarity Schema Setting

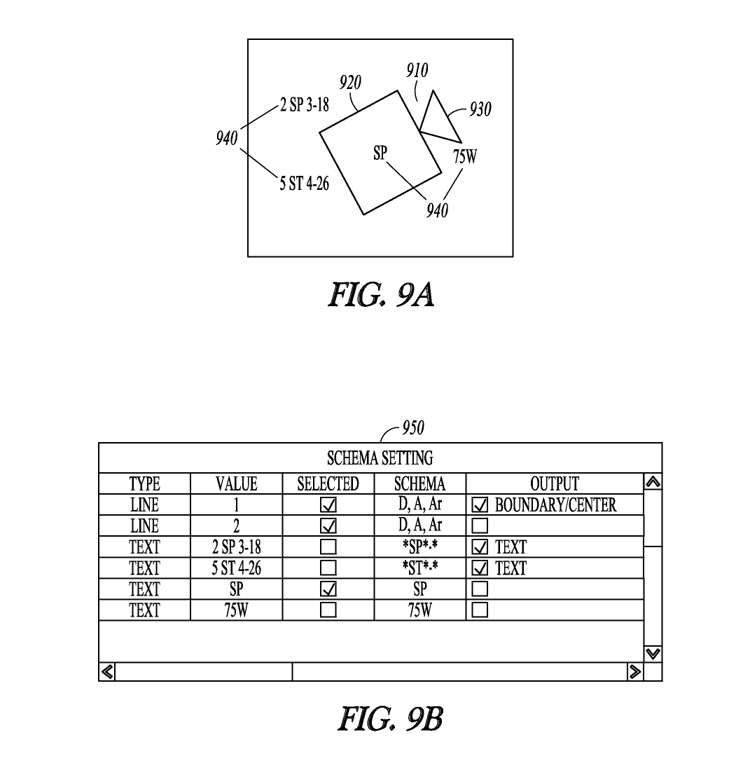

Once a sample is selected, a window will display its primitives. All primitives except text will be marked with a digital number, and the primitives with the same shape will have same number. For example, FIG. 9A shows the primitives for a speaker 910 in a building—two kinds of lines 920, 930 and four instances of text 940. At the same time, all the primitives are also listed in a table 950, as FIG. 9B shows. In FIG. 9B, a user can set the primitives that make up a structure. For example, in FIG. 9B, two kinds of lines and some text are selected to comprise the structure for a speaker. And the line's distance, angle, and orientation, or {<D,A,Aₚ>}, will be considered during the next search period. The validation string expression is “SP”, or {S_{w=‘SP’}}.

Primitive Fragment

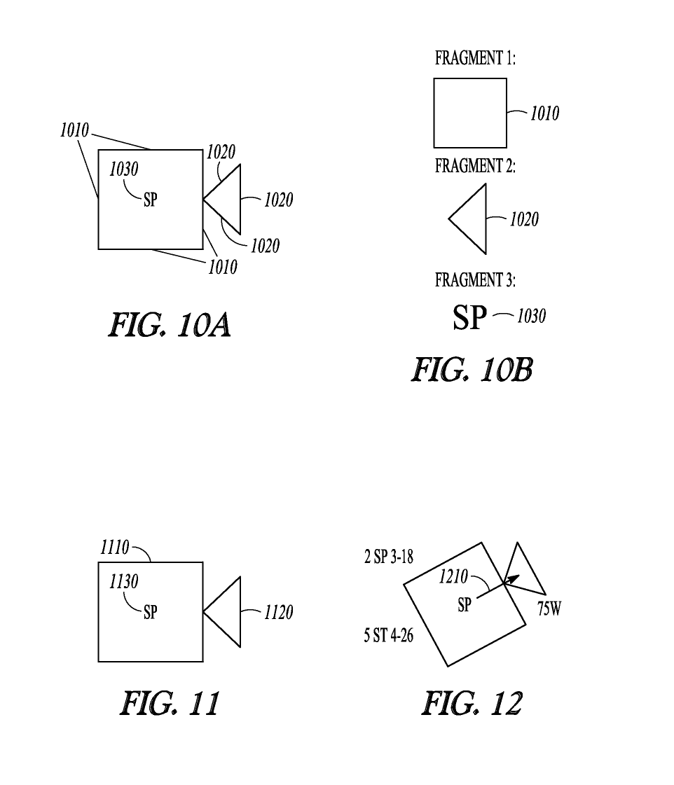

In the lower level, similar primitives are grouped into a Primitive Fragment. Referring to the speaker in FIG. 9A, the sample has 8 primitives, as FIG. 10A shows. The four lines 1010 have the same shape, so they are grouped into a fragment 1. Similarly, the three lines 1020 have the sample shape, so they are grouped into a fragment 2. The text 1030 “SP” is treated as a fragment 3. All of primitive fragments are shown in FIG. 10B. Then its structure model can be obtained with the Primitive Structure Model {<D,A,Aₚ>} and {S_{w=‘SP’}} as described above and as illustrated in FIGS. 10A and 10B.

M(fragment1)=<(15.3, 15.3), {<10.82, 90, 45>, <15.3, 0, 90>, <10.82, 90, 135>}> These are reference numbers 1010 in FIG. 10A.
M(fragment2)=<(9.8, 9,8), {<4.9, 60, 60>, <4.9, 60, 60>}> These are reference numbers 1020 in FIG. 10A.
M(fragment3)=<(“SP”), {S_{w=‘SP’}}> This is reference number 1030 in FIG. 10A.

All the primitives in a Primitive Fragment have the same shape, so any of them can be regarded as its primary primitive. This avoids the redundancy caused by internal symmetry in the sample object. The Primitive Fragment keeps the partial micro structure of the sample object. In the following searching phase, the Primitive Fragments are identified after similar primitives are obtained.

Fragment Structure

After the primitive fragments are obtained, they are converted into points. The location of the points is the center of the fragments, as FIG. 11 shows. The points 1110, 1120 and 1130 represent the primitives fragment1, fragment2 and fragment3 respectively. Similarly, the structure model can be obtained with the Primitive Structure Model {<D,A,Aₚ>} described above:

M(Speaker)=<(0,0), <11.12, 0, 0>, <0, 0, 0>>, that is for 1110, 1120, and 1130 respectively.

All the primitives in a Fragment Structure are points. Here, the primary fragment is regarded as the one with longest curve length. The Fragment Structure of the sample object holds its whole macro structure. In the following searching phase, the object matching is identified against the fragment structure model after the Primitive Fragments are identified.

3. Object Extraction

With the above Primitive Fragment and Fragment Structure, the object extraction becomes straightforward. It has three phases: primitive retrieval, fragment identification, and object identification.

Primitive Retrieval

The primitive retrieval can be described as illustrated below.

| | |
|---|---|
| 1 | for each Primitive Fragment F |

| | |
|---|---|
| 2 | let p as its primary primitive |

| | |
|---|---|
| 3 | for each primitive s in the vector image |

| | |
|---|---|
| 4 | if p is text |

| | |
|---|---|
| 5 | if S_{w}(p) = S_{w}(s), output s |

| | |
|---|---|
| 6 | else |

| | |
|---|---|
| 7 | if S(p) = S(s), output s |

After primitive retrieval, a list of primitives is retrieved for each Primitive Fragment, and can be expressed as the list Lₚ(F). In the above speaker example, three lists can be obtained—L(F1), Lₚ(F2) and Lₚ(F3) after primitive retrieval. They are two line lists and a text list respectively. The lists will be taken as input for the fragment identification in the next section.

Fragment Identification

The Fragment Identification can be described as follows:

| | |
|---|---|
| 1 | for each Primitive List Lₚ (F) |

| | |
|---|---|
| 2 | let p as primary primitive of F |
| 3 | for each primitive s in the list Lₚ |

| | |
|---|---|
| 4 | calculate properties of other primitives q : |
| | Q_{q} =< D(s,q),A(s,q),Aₛ(h,q) > |
| 5 | if a primitive set{q} makes {Q_{q}} satisfy M (F) |

| | |
|---|---|
| 6 | a similar fragment f is gotten, and output f |

| | |
|---|---|
| 7 | delete s and {q} ; |

Else

delete s

After primitive retrieval, a list of Fragments is obtained for each Primitive Fragment, and can be expressed as L_{f}(F). In the above speaker example, three lists can be obtained—L_{f}(F1), L_{f}(F2) and L_{f}(F3) after primitive retrieval. They are a rectangle list, a triangle list, and a text “SP” list. The lists will be taken as input for the Object Identification in the next section.

Object Identification

The object identification is similar to fragment identification. The only difference lies in that the primitive is the point—center of the fragments. After object identification, a list of objects can be obtained that are similar to the sample object O, and they can be expressed as L(O).

4. Meaningful Information Output

After the object extraction described above, the object list L(O) for the sample object O can be obtained. The last step is to obtain any relevant information about the extracted object. In order to do this, its output template is first defined. The template includes the fragment information to be obtained as the partial micro information, and some virtual primitives relative to the sample object as the whole macro information. Once an object is recognized from the vector image, these virtual primitives will also be calculated and obtained according to the Fragment Structure.

Output Template

The partial micro information about the fragment includes text string, boundary, center and so on, as FIG. 10B shows. In the example of FIGS. 10A and 10B, the boundary and center of rectangle will be obtained, and a text string with expression “*SP*-*” around it will also be obtained.

To output the macro information, a user can draw virtual primitives in the sample, as illustrated in FIG. 12. In the example of FIG. 12, a vector 1210 is drawn as the orientation of the speaker.

Output Information Integration

According to the output template, the relevant information can be calculated. For the partial micro information about the fragment, the related information of the specified fragment is obtained. To obtain the entire macro information, the geometric information about virtual primitives on the output template on the Fragment Structure has to be calculated. Furthermore, the retrieved similar objects then can be easily grouped into standard IFC object classes, creating a building semantic model where none existed.

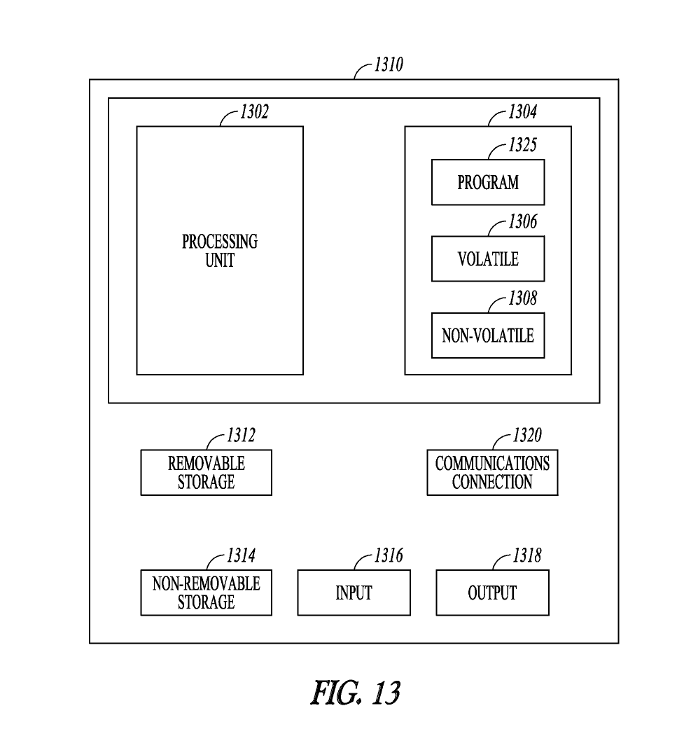

A block diagram of a computer system that executes programming for performing methods described herein is shown in FIG. 13. A general computing device in the form of a computer 1310, may include a processing unit 1302, memory 1304, removable storage 1312, and non-removable storage 1314. Memory 1304 may include volatile memory 1306 and non-volatile memory 1308. Computer 1310 may include—or have access to a computing environment that includes—a variety of computer-readable media, such as volatile memory 1306 and non-volatile memory 1308, removable storage 1312 and non-removable storage 1314. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1310 may include or have access to a computing environment that includes input 1316, output 1318, and a communication connection 1320. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions to execute methods and algorithms described above may be stored on a computer-readable medium such as illustrated at a program storage device 1325 are executable by the processing unit 1302 of the computer 1310. A hard drive, CD-ROM, and RAM are some examples of articles including a computer-readable medium.

The Abstract is provided to comply with 37 C.F.R. §1.72(b) is submitted with the understanding that it will not be used to interpret or limit the scope or meaning of the claims.

1. A method comprising:
receiving a floor plan into a computer processor;
extracting primitive line segments from the floor plan;
decomposing poly lines, curves, and polygons from the floor plan into primitive line segments;
searching for a basic structure in the floor plan using the primitive line segments;
searching for a wall in the floor plan using the primitive line segments;
associating a property to the basic structure and a property to the wall; and
creating a building information model.

2. The method of claim 1, wherein the primitive line segments include one or more of a point, a line, a curve, and text; and wherein the building information model is compliant to one or more of ISO/PAS 16739 (Industry Foundation Classes) or OmniClass™.

3. The method of claim 1, wherein the searching for a basic structure comprises:
creating a template for the basic structure comprising the primitive line segments;
retrieving templates from a structure template library;
utilizing template driven searching to extract the basic structure from the floor plan; and
determining to keep or remove the primitive line segments that are part of the extracted basic structure.

4. The method of claim 3, wherein the basic structure comprises one or more of stairs, a door, and an elevator.

5. The method of claim 3, wherein the associating a property comprises:
distinguishing room and cubicle space types;
associating a name to the basic structure; and
associating a dimension to the basic structure.

6. The method of claim 5, comprising searching one or more of the name and the dimension via the template, wherein the template includes one or more of a wildcard string and a property including one or more of a color, a font, and a size.

7. The method of claim 5, comprising determining that one or more of the name or the dimension is associated with a particular structure and assigning the name or the dimension to the particular structure.

8. The method of claim 1, wherein the searching for a wall comprises:
setting a boundary width value;
collecting the primitive line segments into a list;
generating a graph by filling a vertex list with end points of the primitive line segments;
merging multiple vertices into a group, wherein a position of the group is a center of a bounding box of the group; and
adding edges to the graph when two points of a particular line segment are mapped to two different vertices of the graph.

9. The method of claim 8, comprising using a wall thinning method on a building structure extracted from the floor plan.

10. The method of claim 9, wherein the wall thinning method merges end vertices of parallel lines or curves across a boundary so as to simplify the boundary into a set of line segments and insure that no two lines along the boundary are at the same location.

11. The method of claim 9, comprising merging the building structure as part of a boundary.

12. The method of claim 9, comprising organizing the primitive line segments as a graph data structure, and verifying the building structure by refining wall lines by the primitive line segments, and refining wall lines according to structural design rules.

13. The method of claim 9, comprising associating one or more of a name or a dimension to the building structure extracted from the floor plan.

14. The method of claim 9, wherein the building information model is created from the building structure extracted from the floor plan; and exporting the building information model to a storage device.

15. A computer implemented method comprising:
receiving a vector image into a computer processor;
recognizing and extracting, with the computer processor, an object from the vector image;
exporting the object into a building information model; and
storing the building information model in a computer storage medium.

16. The method of claim 15, wherein the object originates from one or more building domains including mechanical electrical and plumbing (MEP), Heating, Ventilation, and Air Conditioning (HVAC), security, fire, and lighting.

17. The method of claim 15, comprising:
describing a structure of the object and extracting similar objects from the vector image; and
grouping the similar objects into object classes, thereby creating the building information model, wherein the building information model is compliant to one or more of ISO/PAS 16739 (Industry Foundation Classes) or OmniClass™.

18. The method of claim 17, wherein the describing a structure comprises:
capturing a partial micro structure of the object; and
converting the partial micro structure into a macro structure.

19. The method of claim 18, wherein the micro structure comprises one or more of points, lines, curves, text, color, line width, text size, and text font; and wherein the macro structure comprises one or more of a wall, a staircase, and an elevator.

20. The method of claim 15, comprising providing an output template that comprises semantic information about the object; and providing a template for basic structures; wherein the vector image comprises a CAD-based vector image.
